(19) United States
(12) Patent Application Publication
(10) Pub. No.: US 2021/0147178 A1
(43) Pub. Date: May 20, 2021

(54) OPERATING AND/OR DISPLAY PANEL, ELEVATOR CAR SYSTEM AND METHOD FOR MANUFACTURING AN OPERATING AND/OR DISPLAY PANEL

(71) Applicant: Inventio AG, Hergiswil (CH)

(72) Inventor: Hugo Felder, Buchrain (CH)

(21) Appl. No.: 16/622,324

(22) PCT Filed: Jun. 13, 2018
(86) PCT No.: PCT/EP2018/065659

§ 371 Date: Dec. 13, 2019

(30) Foreign Application Priority Data
Jun. 14, 2017 (EP) 17176035.8

(51) Int. Cl. B66B 1/46; B66B 3/00

(52) U.S. Cl. CPC B66B 1/467; B66B 2201/4638; B66B 3/002

(57) ABSTRACT

An operating and/or display panel, for operating an elevator car and/or for displaying information about the elevator car, includes a housing with two opposing bent lateral end sections, wherein each lateral end section delimits an inner space, and a control board for operating the elevator car and/or a display. The control board is disposed in at least one of the inner spaces of the bent lateral end sections of the housing.

### FIELD

The present invention pertains to an operating and/or display panel, an elevator car system and a method for manufacturing an operating and/or display panel.

### BACKGROUND

Operating and/or display panels of an elevator car typically comprise a housing with two opposite bent end sections. The end sections are bent for increasing the stability of the housing or panel. The panel comprises a control board which controls the elevator car and/or a display. Many communication elements (HMI—human machine interfaces), e.g., a button pad for controlling the movement of the elevator and/or display elements and/or intercom elements and/or loudspeaker elements, with which the user communicates with the elevator car or vice versa have to be disposed within the housing between the two bent end sections and have to be connected to the control board. Usually, the control board is disposed at the upper or lower end of the panel.

One disadvantage of panels known from the state of the art is that the space for communication elements is very limited since the control board needs much space. Furthermore, every communication element has to be connected via a cable and/or wire to the control board. This can create a disorder of many cables since the number of communication elements is typically high and the cables are very long usually, since the distances between the communication elements and the control board can be large.

There can be the need for an operating and/or display panel for operating an elevator car and/or for displaying information about the elevator car and an elevator car system wherein there is much space available in the housing of the operating and/or display panel for communication elements to be disposed and wherein the connecting of the communication elements to the control board can be achieved technically easily and with a clear structure. Also, there can be the need for a method for manufacturing an operating and/or display panel wherein there is much space left in the housing of the manufactured panel for communication elements to be disposed and wherein the connecting of the communication elements to the control board can be achieved technically easily and with a clear structure.

### SUMMARY

According to a first aspect, an operating and/or display panel for operating an elevator car and/or for displaying information about the elevator car is proposed, wherein the panel comprises—a housing with two opposing bent lateral end sections, wherein each lateral end section delimits an inner space, and—a control board for operating the elevator car and/or a display, characterized in that the control board is disposed in at least one inner space of the bent lateral end sections of the housing.

One advantage hereof is that previously unused space (in the opposing bent end sections) of the housing is used for the control board, in general. Typically, this frees space outside of the opposing bent end sections for the communication (HMI) elements. Thus, in general, more space is available for communication elements and/other elements. Furthermore, typically, the cabling of the communication elements to the control board is technically simplified and clearer.

According to a second aspect, an elevator car system comprises—an elevator car and—an operating and/or display panel with one or more combinations of features as described above, wherein the operating and/or display panel is installed in the elevator car.

According to a third aspect, a method for manufacturing an operating and/or display panel for operating an elevator car and/or for displaying information about the elevator car is proposed, comprising the following steps: providing a housing with two opposing bent lateral end sections, wherein each lateral end section delimits an inner space, inserting a control board for operating the elevator car and/or a display in at least one of the inner spaces of the bent end sections, and attaching the control board to the housing.

One advantage of this method is that a panel is manufactured wherein previously unused space (in the opposing bent end sections) of the housing is used for the control board, in general. Typically, this frees space outside of the opposing bent end sections for the communication elements. Thus, generally, in a panel manufactured with this method, more space is available for communication elements and/or other elements. Furthermore, usually, the cabling of the communication elements to the control board can be technically simplified.

The inner space of the end sections of the housing extends from the lateral outermost part of the end sections to the tips or ends of the end sections, respectively. The inner space extends along most of or all of the height of the panel. The end sections delimit the inner spaces, respectively, i.e., the end sections form at least a part of the boundary between the respective inner space which is inside the housing and the outer space which is outside of the housing. In particular, the bent end sections can have a bent angle of ca. 180° in total, i.e., the tip of one end section is bent towards the tip of the other end section, or can have a bent angle of 180° and 90°, i.e., part of the end section is bent towards the other end section, while the tips of the end sections run in parallel to each other. This means that each end section is first bent in an angle of 180° and then in an angle of 90° wherein the directions of the two angles is contrary to each other.

Possible features and benefits of the embodiments of the invention can be based, among others and without limiting the invention, on the ideas and findings described in the following.

According to an embodiment, the control board extends over at least 75%, in particular at least 90%, of a height of the panel. By this, typically, the multitude of cables is distributed over a large portion of the height of the panel. Thus, generally, the cables can be separated from each other clearly. Hence, usually, the wiring and/or cabling of the communication elements to the control board can be further simplified.

According to an embodiment, the panel further comprises communication elements, in particular a button pad for controlling the movement of the elevator car and/or display elements and/or intercom elements and/or loudspeaker elements, wherein the control board comprises connections for connecting the control board to the respective communication element, wherein the connections of the control board are essentially at the same height as the respective communication element. By this, typically, the wiring and/or cabling of the communication elements to the control board is even further technically simplified. Furthermore, generally, the lengths of the cables and/or wires can be reduced.

According to an embodiment, the communication elements are connected to the control board via a control board connector, a cable and a communication element connector, respectively. One advantage hereof is that the technical complexity of the panel is reduced, in general. Typically, this increases the safety of the cabling. Furthermore, the cabling and/or wiring is robust. Also, in general, the cable(s) can be exchanged technically easily, respectively.

According to an embodiment, the respective cable runs essentially perpendicular to the height of the panel. This reduces the lengths of the cables and/or wires from the communication elements to the control board, in general. Furthermore, typically, the wiring and/or cabling is further simplified.

According to an embodiment, the control board connector is connectable to the control board detachably, in particular via a snap-on connection. By this, typically, the control board can be mounted to the housing in a short amount of time. Furthermore, generally, a replacement of the control board can be carried out technically easily and in a short amount of time.

According to an embodiment, the control board comprises at least two control board elements which are interconnected. One advantage hereof is that both opposing bent end sections can be used for the control board, in general. Thus, typically, a control board which needs much space can be disposed in or within the bent end sections of the housing. Hence, generally, even with a large control board, there is a lot of space in the housing left for the communication elements and/or other elements in the housing.

According to an embodiment, the panel further comprises labels at the connections of the control board, respectively, for identifying the respective connection of the control board. By this, typically, the chances that the communication element is connected to the wrong connection of the control board, i.e., to a connection of the control board not intended or designated for the respective communication element, are decreased significantly. In general, this increases the safety.

Is has be noted that some of the possible features and benefits of the invention are described herein with reference to different embodiments. A person skilled in the art understands that the features can be combined, adapted or be replaced conveniently to arrive at further embodiments of the invention.

In the following, embodiments of the invention are described with reference to the figures enclosed, wherein neither the figures nor the specification should be construed as limiting the invention.

### DESCRIPTION OF THE DRAWINGS

FIG. 1 shows a schematic end view of a first embodiment of an operating and/or display panel according to the present invention;

FIG. 2 shows a schematic front view of the first embodiment of the operating and/or display panel according to the present invention; and

FIG. 3 shows a schematic end view of a second embodiment of an operating and/or display panel according to the present invention.

The figures are only schematic and not to scale. Same reference signs denote same features or features with the same effect in the different figures.

### DETAILED DESCRIPTION

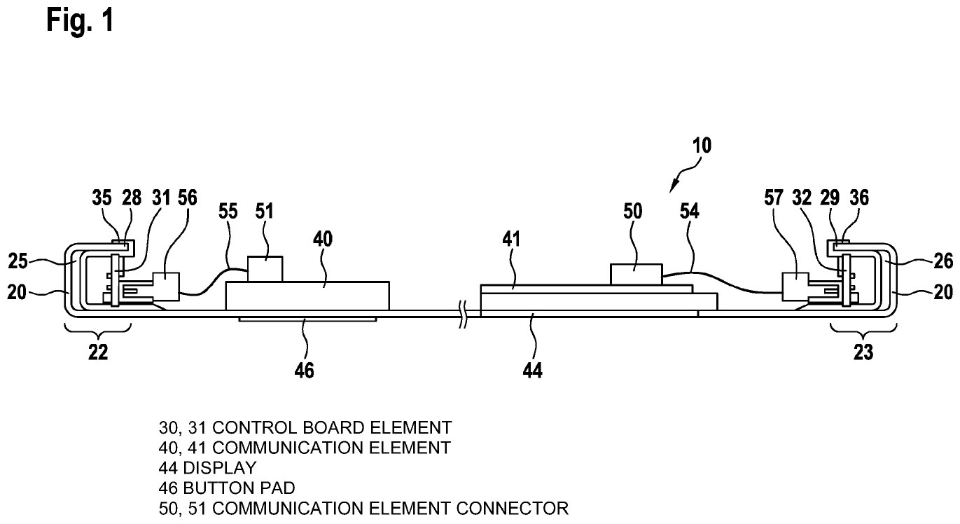

FIG. 1 shows a schematic end view of a first embodiment of an operating and/or display panel 10 according to the invention. The panel 10 comprises a housing 20 which has two bent lateral end sections 22, 23. The lateral sides of the panel 10 are on the left side and the right side of FIG. 1, respectively.

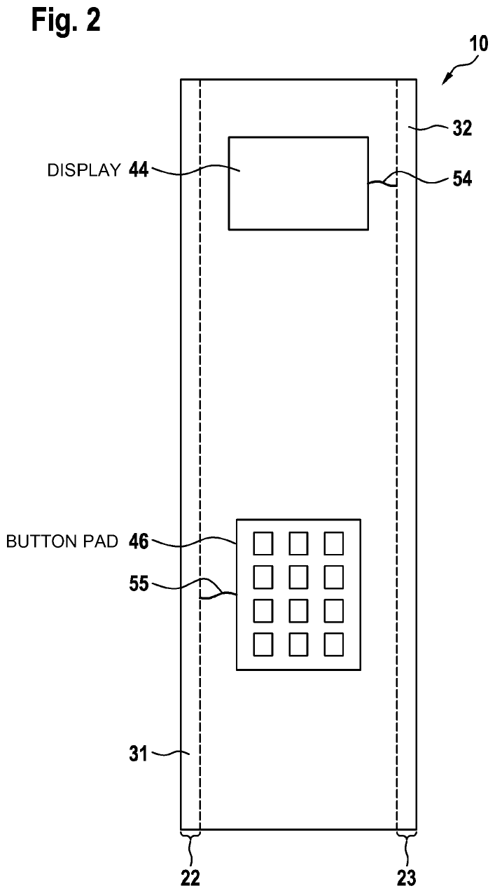

FIG. 2 shows a schematic front view of the first embodiment of the operating and/or display panel 10 according to the present invention.

The bottom part of the housing 20 in FIG. 1 will be oriented towards the inside of the elevator car in use. The section between the opposing ends 28, 29 of the end sections 22, 23 can be closed with a lid or cover in use. The lid or cover is oriented away from the inside of the elevator car in use.

The two bent lateral end sections 22, 23 are symmetric to a plane which runs from top to bottom in FIG. 1 and which runs perpendicular to the plane of projection. In FIG. 1, the two bent end sections 22, 23 have the form of the capital Latin letter C. The space inside the part which has the form of the capital Latin letter C is the inner space 25, 26, respectively. The height of the panel 10 runs perpendicular to the plane of projection. FIG. 1 does not show the middle part of the panel 10. The middle part of the panel 10 is omitted.

The panel 10 can be installed in an elevator car. Alternatively or additionally, the panel 10 can be installed at the entrance of the elevator shaft at one or more of the floors.

The panel 10 comprises a control board 31, 32. The control board 31, 32 is adapted for operating the elevator car and/or a display 44. The control board 31, 32 is provided (mainly) inside the inner spaces 25, 26 of the bent lateral end sections 22, 23 or within the bent lateral end sections 22, 23. The control board 31, 32 comprises two control board elements 31, 32. One control board element 31, 32 is provided in each of the two inner spaces 25, 26 of the bent lateral end sections 22, 23.

Only a minor part of the control board 31, 32 or control board elements 31, 32, e.g., less than 10% or less than 5%, projects out of the inner spaces 25, 26 or the lateral end sections 22, 23, respectively. The two control board elements 31, 32 are electrically interconnected, e.g., via at least one wire or cable or wirelessly. It is also possible, that all elements of the control board 31, 32 are within the inner spaces 25, 26. I.e., no part of the control board 31, 32 projects out of the inner spaces 25, 26.

The control board 31, 32 runs along a major part of the height of the panel 10. In particular, the control board 31, 32 can run along the full height of the panel 10.

The panel 10 comprises several communication elements 40, 41. The communication elements 40, 41 shown in FIG. 1 are provided at different heights of the panel 10.

The communication elements 40, 41 are elements for communication between the user and the elevator car, or vice versa. The communication elements 40, 41 can comprise a button pad 46 for choosing the floor to which the elevator should be moved, displays for displaying information about the elevator car (e.g., the floor at which the elevator car is located and/or the floor(s) to which the elevator car is being moved), an emergency button, buttons for opening and/or closing the elevator car doors, loudspeaker and/or microphone elements for communicating with a central emergency center, and/or intercom elements.

Each communication element 40, 41 comprises a communication element connector 50, 51 which is mounted at the communication element 40, 41. The communication element connector 50, 51 (e.g., display element connector 50 or button pad connector 51) is connected to a cable 54, 55. At the opposite end of the cable 54, 55, a control board connector 56, 57 is provided which can be connected to a connection of the control board 31, 32.

The control board 31, 32 has connections for the communication elements 40, 41. The respective connection of the control board 31, 32 is at the height where the respective communication element 40, 41 is provided. By this, the cabling and/or wiring is technically simple and clear. Furthermore, the lengths of the cables 54, 55 can be very short, respectively.

The cables 54, 55 and/or wires for connecting the respective communication element 40, 41 with the control board 31, 32 electrically run essentially perpendicular to the height of the panel 10. This is shown in FIG. 2. The height (longitudinal axis) of the panel 10 runs from bottom to top in FIG. 2.

By providing the control board 31, 32 in the bent lateral end sections 22, 23 of the housing 20 or the inner spaces 25, 26 of the bent lateral end sections 22, 23 of the housing 20, there is much space between the sections 25, 26 available for the communication elements 40, 41 and/or other elements in the housing 20.

The control board 31, 32 is mounted at the housing 20 via attachment means 35, 36. In particular, the control board 31, 32 can be mounted at the housing 20 via a snap-on connection. This way, the control board 31, 32 and/or control board elements 31, 32 can be mounted in a short amount of time and can be replaced in a short amount of time.

It is possible that one or more than one label is provided at the respective connection of the control board 31, 32. This way, the person installing the panel 10 and/or control board 31, 32 can identify the respective connection of the control board 31, 32 easily. Thus, making a false connection between the communication element 40, 41 and the control board 31, 32, i.e., connecting the communication element 40, 41 to a connection of the control board 31, 32 which is not designated for connecting the respective communication element 40, 41, is essentially prevented.

The control board 31, 32 receives the signals from the button pad 46 inside the elevator car. The control board 31, 32 can operate or control the movement of the elevator car directly based on the calls from within the elevator car and/or the floors or can forward the signals to a central control board. The central control board can be part of the elevator shaft and/or a central control device.

Furthermore, the control board 31, 32 operates or controls the display 44, i.e., what is displayed on the display(s) 44. Also, the display(s) 44 can be used for inputting data to the control board 31, 32. The displays can be touch-screen displays.

One of the communication elements 40, 41 comprises a button pad 46 for inputting the floor number to which the elevator car shall move. The button pad 46 is mounted on the communication element 40 oriented towards the interior of the elevator car in use as shown in FIG. 1. The other communication element 41 comprises a display 44 for displaying information to the user within the elevator car.

The ends 28, 29 of the two lateral end sections 22, 23 of the housing 20 are orientated towards each other.

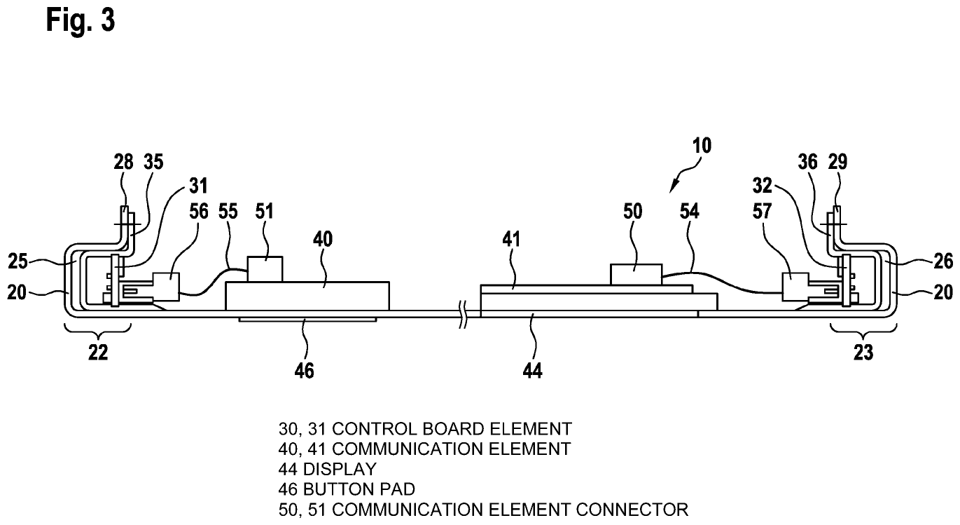

FIG. 3 shows a schematic view of a second embodiment of an operating and/or display panel 10 according to the present invention. The difference between the first embodiment and the second embodiment is the form of the bent lateral end sections 22, 23 and the attachment means 35, 36 for attaching the control board 31, 32 to the housing 20.

In the second embodiment, the housing 20 has a T-profile. This means that the two lateral end sections 22, 23 have partly the form of the capital Latin letter C followed by a short tip or end which runs parallel to the depth of the panel 10 (i.e., the short tip or end runs from bottom to top in FIG. 3) and parallel to each other.

The communication elements 40, 41 shown in FIG. 1 are provided at different heights of the panel 10 shown in FIG. 3.

Alternatively, the two bent end sections 22, 23 can have the form of the capital Latin letter L or of the capital Latin letter C with a rounded shape in a cross-section perpendicular to the height of the panel 10, respectively. Other forms of the end sections 22, 23 are possible. The end sections 22, 23 can be symmetric relative to a plane that runs along the height of the panel 10 and through the middle of the panel 10. Alternatively, the end sections 22, 23 can be non-symmetric relative to a plane that runs along the height of the panel 10 and through the middle of the panel 10.

The control board elements 31, 32 can run along the depth of the panel 10, respectively, being arranged in an angle to the panel of or about 90°, e.g. 85°-95°, the depth of the panel 10 running from bottom to top in FIGS. 1 and 3.

Alternatively, the control board elements 31, 32 can run in an angle relative to the direction of the depth of the panel 10, respectively, e.g. following a tilted side wall section of the lateral end section.

In concluding, it has to be noted that terms like “having”, “comprising”, etc. do not excluded other elements or steps and terms like “a” or “an” do not exclude a plurality. Furthermore, it should be noted that features or steps described with reference to one of the embodiments above, can be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE NUMERALS

10 Operating and/or display panel
20 housing
22, 23 lateral end sections
25, 26 inner space
28, 29 ends of the end sections
31, 32 control board elements
35, 36 attachment means
40, 41 communication element
44 display
46 button pad
50 communication element connector (display element connector)
51 communication element connector (button pad connector)
54, 55 cable
56, 57 control board connector

1-13. (canceled)

14. An operating and/or display panel for operating an elevator car and/or for displaying information about the elevator car, the panel comprising:
a housing having two opposing bent lateral end sections, wherein each of the lateral end sections delimits an inner space;
a control board for operating the elevator car and/or a display attached to the housing; and
wherein the control board is disposed in at least one of the inner spaces of the bent lateral end sections of the housing.

15. The panel according to claim 14 wherein the control board extends over at least 75% of a height of the panel.

16. The panel according to claim 14 wherein the control board extends over at least 90% of a height of the panel.

17. The panel according to claim 14 including at least one communication element for at least one of controlling a movement of the elevator car, a display element, an intercom element and a loudspeaker element, wherein the control board includes a control board connector for connecting the control board to the at least one communication element, and wherein the control board connector is positioned at about a same height in the housing as the at least one communication element.

18. The panel according to claim 17 wherein the at least one communication element is a button pad for controlling the movement of the elevator car.

19. The panel according to claim 17 wherein the at least one communication element is connected to the control board via the control board connector, a cable and a communication element connector.

20. The panel according to claim 19 wherein the cable runs perpendicular to a longitudinal axis of the panel.

21. The panel according to claim 19 wherein the control board connector is detachably connected to the control board.

22. The panel according to claim 19 wherein the control board connector is connected to the control board by a snap-on connection.

23. The panel according to claim 14 wherein the control board has at least two control board elements.

24. The panel according to claim 23 wherein one of the at least two control board elements is disposed in the at least one of the inner spaces and another of the at least two control board elements is disposed in another of the inner spaces

25. The panel according to claim 23 wherein the at least two control board elements are electrically interconnected.

26. The panel according to claim 14 wherein the control board extends at an angle of about 90° to a plane extending along a height of the panel.

27. The panel according to claim 14 wherein at least one of the bent lateral end sections of the housing has a side wall and wherein the control board runs along the side wall.

28. The panel according to claim 14 wherein the panel is an operating and/or display panel adapted to be installed in an elevator car.

29. A method for manufacturing an operating and/or display panel for operating an elevator car and/or for displaying information about the elevator car, the method comprising the following steps:
providing a housing with two opposing bent lateral end sections, wherein each of the lateral end sections delimits an inner space;
inserting a control board for operating the elevator car and/or a display at the housing in at least one of the inner spaces of the bent lateral end sections; and
attaching the control board to the housing.
